(19) United States
(12) Patent Application Publication
(10) Pub. No.: US 2024/0075550 A1
(43) Pub. Date: Mar. 7, 2024

(54) LASER MACHINING HEAD COMPRISING A CHROMATIC COMPENSATION DEVICE

(71) Applicant: PRECITEC GMBH & CO. KG, Gaggenau (DE)

(72) Inventor: David Blazquez Sanchez, Gaggenau (DE)

(21) Appl. No.: 18/273,679

(22) PCT Filed: Dec. 23, 2021
(86) PCT No.: PCT/EP2021/087520

§ 371 Date: Jul. 21, 2023

(30) Foreign Application Priority Data
Jan. 26, 2021 (DE) 102021101658.4

(51) Int. Cl. B23K 26/03; B23K 26/06; B23K 26/082

(52) U.S. Cl. CPC B23K 26/032; B23K 26/0648; B23K 26/082

(57) ABSTRACT

A laser machining head for material processing with a laser includes: a focusing optics for focusing the laser beam; an exit opening for the laser beam; an optical sensor arrangement; a coupling optics for coupling light entering through the exit opening out of the beam path of the laser beam to the sensor arrangement; an optics for adjusting a focal position of the laser beam, which has at least one adjustable optical element for adjusting the focal position of the laser beam; and a compensating optics for correcting a chromatic aberration, caused by the focusing optics, of the light coupled out to the sensor arrangement. The compensating optics are arranged between the coupling optics and the sensor arrangement and are arranged for adjusting a focal position of the light coupled out to the sensor arrangement.

### CROSS-REFERENCE TO RELATED APPLICATIONS

This application is the U.S. National Stage of PCT/EP2021/087520 filed on Dec. 23, 2021, which claims priority to German Patent Application 102021101658.4 filed on Jan. 26, 2021, the entire content of both are incorporated herein by reference in their entirety.

### FIELD OF THE INVENTION

The present invention relates to a laser processing head for processing a workpiece by means of a laser beam, comprising a sensor arrangement for process monitoring, open-loop process control and/or closed-loop process control.

### BACKGROUND OF THE INVENTION

With a laser processing head for material processing with lasers, in particular for processing a workpiece by means of a laser beam, the laser beam emerging from a laser light source or one end of a laser guiding fibre is focused onto the workpiece to be processed with the aid of a beam guiding and focusing optics. The processing may include, for example, laser cutting, soldering or welding. The laser processing head may be, for example, a laser cutting head or a laser welding head.

Especially when remotely welding the workpieces with curved surfaces, it is important to be able to adjust the focal position of the laser processing beam, i.e. the position of the laser focus in height. To ensure the quality of the machining, it is desirable to continuously monitor a welding or brazing process. Monitoring a machining process is typically done by detecting and assessing various parameters of a process radiation, also called process beam, process light or process emissions. These include, for example, laser light backscattered or reflected back from a surface of the workpiece, plasma radiation generated by the machining process, process emissions in the infrared range of light such as temperature radiation or process emissions in the visible range of light.

The detection of process light from an environment of the laser processing point is typically carried out by means of a sensor arrangement arranged on the laser processing head as part of the same. The process light is coupled into the sensor arrangement from laser optics or from the beam path of the laser beam of the laser processing head. The sensor arrangement typically contains several detectors or sensors that detect various parameters of the process light and output them as a measurement signal.

### STATE OF THE ART

DE 102012001609 B3 describes a laser processing head for processing a workpiece by means of a working laser beam, having beam-shaping optics for collimating a working laser beam emerging from one fibre end of an optical fibre, focusing optics for focusing the working laser beam onto the workpiece surface or onto a position defined relative to the workpiece surface, and having a camera with adjustable imaging optics arranged in front of it in the beam path. In one example, an evaluation unit processes image data from the camera. If a focal point shift of the focusing optics and the beam shaping optics occurs during the processing of the workpiece due to heating of the focusing optics and the beam shaping optics, the camera image of the workpiece surface is brought into focus again by passing the imaging optics through a correction adjustment path by means of an actuator by controlling the evaluation unit.

DE 102008060384 B3 describes a sensor system for monitoring a laser processing operation to be performed on a workpiece.

CN 109366015 A describes a laser cutting device with a 4f system comprising a convex lens and an achromatic focusing lens. A beam splitter disposed between the convex lens and the achromatic focusing lens reflects illumination light from the object to be cut onto a CCD imaging system.

U.S. Pat. No. 9,079,268 B2 describes a device for material ablation by laser. A mirror with a hole decouples the UV laser beam passing through the hole from a sample view. A laser objective lens focuses only the UV laser light, while a camera view of white light is separately focused by an achromatic visible light lens.

U.S. Pat. No. 9,757,817 B2 describes a laser welding apparatus with separate lenses for focusing the high power process beam and scanning an imaging beam.

WO 2019/151911 A1 describes a laser tool device with a control device for controlling a position of a laser beam on a workpiece surface based on image processing. Reflections from the workpiece are focused onto a camera by an adjustable focusing lens.

DE 102016208264 A1 relates to a method for monitoring, in particular for controlling, a cutting process.

### SUMMARY OF THE INVENTION

In a laser processing head having a focal position adjusting device for adjusting the focal position of the laser beam in the direction of the laser beam, i.e. in the height direction or z-direction, and having a coaxially coupled sensor arrangement, the sensor arrangement usually comprises a sensor operating in a spectral range comprising wavelengths other than that of the laser. Therefore, due to chromatic aberration of the laser focusing optics, the problem arises that the imaging properties of the focusing optics are different for the spectral range of the sensor than for the wavelength of the laser light. Furthermore, the imaging characteristics of the focusing optics for the spectral range of the sensor may change differently when adjusting the focal position of the laser beam than the imaging characteristics for the wavelength of the laser light. The characteristics of the light detected by the sensor are then no longer clearly related to the characteristics of the laser light that are effective for laser processing. The chromatic aberration has the consequence that, depending on the focal position of the laser beam, the signal detected by the sensor is defocused. For example, the sensor cannot monitor the process light with the same precision at different focal positions of the laser beam on the workpiece. Chromatic aberration here means in particular a (wavelength-dependent) defocusing.

To avoid chromatic aberration for different focal positions of the laser beam, different lenses made of different materials with different dispersion (or different ratio of refractive index and dispersion) would have to be combined in the focusing optics for the laser. In laser material processing with fibre-coupled laser sources and a wavelength of the order of 1 μm, quartz glass is often used as the material for lenses, while lenses made of zinc selenide or zinc sulphide are used, for example, for CO2 laser systems with a wavelength of the order of 10 μm. However, the use of lenses made of crystalline material poses a problem due to the very high power in laser processing, especially for fibre-coupled lasers in the multi-kilowatt power range. This is because when small particles or impurities strongly absorb the laser energy at wavelengths in the order of 1 μm, the different materials show different behaviour. While lenses made of quartz glass melt in the case of excessive absorption of laser energy, resulting in a simple repair, lenses made of crystalline material can shatter in the case of excessive absorption of laser energy, resulting in major damage to the laser processing head, up to and including total failure. In addition, crystalline materials have other disadvantages, such as a higher price, greater supply limitations or birefringence.

It is a task of the invention to create a laser processing head for material processing with lasers, which allows better process monitoring by a sensor arrangement even when the focal position of the laser beam is changed. Furthermore, it is a task of the invention to ensure reliable monitoring of laser machining processes even on workpieces with curved surfaces. It is also a task of the invention to improve the detection of light from a surrounding area of the laser processing point, in particular the laser focus, by means of a sensor arrangement on the laser head. In this context, it is desirable to couple a sensor arrangement coaxially with the laser beam in order to achieve completely direction-independent laser processing, as well as monitoring independent of the orientation of the workpiece.

One or more of the tasks are solved by the subject-matter as disclosed herein. Advantageous embodiments and further embodiments are also disclosed.

According to one aspect of the present disclosure, a laser processing head, in particular for material processing with lasers, is disclosed comprising: a focusing optics for focusing the laser beam (to a laser focus); an exit opening for the laser beam; a sensor arrangement; a coupling optics for coupling light entering through the exit opening out of the beam path of the laser beam to the sensor arrangement, in particular for coupling out of the beam path of the laser beam; and compensating optics for correcting a chromatic aberration, caused by the focusing optics, of the light coupled out to the sensor arrangement, the compensating optics being arranged between the coupling optics and the sensor arrangement. The laser processing head may further comprise an entrance aperture for a laser beam. The sensor arrangement may be an optical sensor arrangement or a sensor arrangement for detecting light and may be used for process monitoring, open-loop process control and closed-loop process control. The light may be process light, in particular back-reflected laser beam, IR radiation and/or UV radiation.

The laser focus refers to a focal position of the laser beam. The laser beam is used for material processing, i.e. for acting on a workpiece, and can also be referred to as a laser processing beam or laser light. Preferably, the laser focus is outside the laser processing head. Preferably, the laser focus is behind the exit opening in the beam propagation direction of the laser beam.

The laser processing head may in particular be a laser welding head or a laser cutting head.

The focusing optics can, for example, be part of an optics in the laser processing head for adjusting a focal position of the laser beam, for example an optics for guiding the laser beam and focusing the laser beam. The optics may comprise, for example, a collimating optics and the focusing optics. The optics may comprise a deflection optics. The focusing optics may comprise a lens, for example an F-theta objective, or a lens group. Similarly, the collimating optics may comprise a lens or lens group. The collimating optics may be arranged to at least approximately collimate divergent incoming laser light. The coupling device is preferably arranged between the collimating optics and the focusing optics. The collimating optics may, for example, be arranged to emit a collimated, i.e. focused, laser beam. The focusing optics may comprise at least one optical element, e.g. at least one lens, preferably made of quartz glass. Part of the optics, in particular the collimating optics or the focusing optics, can be arranged to adjust a focal position of the laser beam. For this purpose, the optics can be connected to a focal position adjustment device of the laser processing head.

The sensor arrangement is preferably a photosensitive or optical sensor arrangement. The sensor arrangement may comprise at least one sensor, for example a photodiode, sensitive to a range of wavelengths of light, which light may include IR radiation, visible light, and UV radiation. The sensor arrangement is arranged outside the beam path of the laser beam.

The light coupled out to the sensor arrangement may comprise, for example, light from a vicinity of the laser processing point or the laser focus. The light coupled out to the sensor arrangement can comprise, for example, light of a focal plane (focal position) of the sensor arrangement, in particular light of a focal plane (focal position) of the sensor arrangement in the vicinity of the laser focus. The focal position (in particular focal plane) of the light coupled out to the sensor arrangement may also be referred to as the focal position (or focal plane) of the sensor arrangement. A focal position of the sensor arrangement may be, for example, a focal position of at least one sensor of the sensor arrangement. The light coupled out to the sensor arrangement may, for example, be light coupled out of the beam path of the laser beam and coaxial with the laser beam from a vicinity of the laser processing point or the laser focus.

The coupling optics may also be referred to as a coupling device or decoupling device. It may be arranged to couple out light to be monitored after passing through the focusing optics coaxially with the beam path of the laser beam.

The compensating optics is arranged outside the beam path of the laser beam. Since the compensating optics are thus not exposed to the high-energy laser beam, materials for the compensating optics can be selected more freely. Preferably, the light coupled out to the sensor arrangement is guided as a free beam between the coupling optics and the compensating optics and/or between the compensating optics and the sensor arrangement.

The compensating optics can also be referred to as a compensating system or correcting system or correcting optics. The compensating optics is arranged to correct a chromatic aberration of the light coupled out to the sensor arrangement caused by the focusing optics. In particular, this can mean bringing together the different focal positions (in particular focal planes) of the light of at least two different wavelengths that is coupled out to the sensor arrangement due to the chromatic aberration of the focusing optics. Correcting a chromatic aberration of the light coupled out to the sensor arrangement caused by the focusing optics may comprise correcting the chromatic aberration for at least one wavelength of light that differs from a wavelength of the laser beam. Correcting a chromatic aberration of the light coupled out to the sensor arrangement caused by the focusing optics may comprise correcting the chromatic aberration for at least two different wavelengths of the light. One of these may be the wavelength of the laser beam.

The chromatic aberration of the light coupled out to the sensor arrangement caused by the focusing optics may also be referred to as a chromatic aberration of the focusing optics appearing in the light coupled out to the sensor arrangement. The latter expresses that the chromatic aberration is a property (an aberration) of the focusing optics that shows or manifests itself in the light coupled out to the sensor arrangement. In particular, the focusing optics refracts or diffracts light of different wavelengths of the light then coupled out to the sensor arrangement in different ways.

The basic idea is to provide in the beam path of the (preferably coaxially) coupled optical sensor arrangement a correcting system in the form of the compensating optics, which is arranged outside the beam path of the laser beam, the compensating optics being arranged to at least partially correct the chromatic aberration of the focusing optics. In this way, the compensating optics can correct the focusing optics, which has a chromatic aberration for the light coupled out to the sensor arrangement, to an achromatic or at least approximately achromatic optical system. In particular, it is advantageous to minimise the aberration to acceptable values in order to achieve a technological improvement for laser material processing. The focusing optics can have different refractive power for light of different wavelengths. This so-called chromatic dispersion is the cause of chromatic aberration.

In particular, a compensating optics can be provided, which is arranged in the beam path between a coupling optics and a sensor of the sensor arrangement. Therefore, the light effective for laser processing does not pass through the correcting system (compensating optics) (i.e. not in the path towards the workpiece or the laser focus). In other words, the correction system is not located in the beam path from the laser light supply to the workpiece, but outside. The correction system is therefore exposed to light of a much lower power. A particular advantage of this is that a wide range of materials can be used for the compensating optics, including crystalline materials that would be problematic in the laser processing beam, or plastics, for example. This makes chromatic correction much easier. The laser processing head may also comprise a filter between the coupling optics and the compensating optics to further reduce the light output for at least one wavelength range.

By achromatic optical system or achromatic optics is meant an optical system that has no chromatic aberration for at least two separate (spaced) wavelengths along an optical axis, such as having an equal or approximately equal focal length. For example, the achromatic system can refract and/or diffract these two wavelengths in a geometrically identical manner outside the system. In particular, two light beams of the respective wavelengths emanating from the same focal position may have the same path outside the achromatic optical system.

For example, chromatic aberration can be corrected by reducing the chromatic aberration caused by the focusing optics of the light coupled out to the sensor arrangement by the compensating optics. In other words, the chromatic aberration of the system comprising the focusing optics and the compensating optics is less than the chromatic aberration of the focusing optics alone, i.e. without the compensating optics.

The correcting can be done by changing imaging properties of the compensating optics for at least one of two wavelengths, where for the two wavelengths the chromatic aberration is corrected. For example, the chromatic aberration may be corrected for two wavelengths, one of which is the wavelength of the laser beam (laser wavelength) and the other of which is another wavelength, in particular a wavelength of light detected by the sensor arrangement.

The coupling optics couples light entering through the exit opening out to the sensor arrangement. Preferably, the coupling optics is arranged to couple light entering through the exit opening and coaxial with the laser beam out to the sensor arrangement. The sensor arrangement can thus be coupled coaxially with the laser beam. In particular, the coupling optics can couple light that is coaxial with the laser beam out to the sensor arrangement in the opposite direction with respect to the laser beam.

The coupling optics can, for example, be arranged to couple out light entering the laser processing head through the exit opening to the sensor arrangement with wavelengths in a spectral working range of the sensor arrangement.

Through the coupling optics, a part of the radiation entering the laser processing head through the exit opening is coupled out to the sensor arrangement. The chromatic aberration of the focusing optics that occurs for the radiation can be compensated for at the position between the sensor arrangement and the coupling optics, so that the entire sensor arrangement benefits from the chromatic correction.

The coupling optics may comprise, for example, a beam splitter, a mirror with a through hole for the laser beam, or a dichroic mirror. Through a dichroic mirror, for example, light with the wavelength of the laser beam can be transmitted, while light with other wavelengths can be coupled out to the sensor arrangement. In this case, with a high luminous intensity of retroreflecting laser light, a small proportion of the retroreflecting laser light can also be coupled out to the sensor arrangement and detected or monitored by a sensor. Advantageously, the decoupling by reflection at the dichroic mirror is not based on absorption, so that there is no excessive power consumption of the coupling optics.

In a particularly advantageous manner, the invention is used with a laser processing head that has a focal position adjustment device for the laser focus, in particular a focal position adjustment device for adjusting the focal position of the laser beam in the direction of the optical axis of the laser beam. In a particularly advantageous manner, the invention is used in a laser processing head having a focal position adjusting device for the laser focus, wherein the laser processing head comprises a control unit arranged to open-loop control or closed-loop control a focal position of the laser beam by means of the focal position adjusting device. For this purpose, the control unit may be arranged to evaluate an output signal of a sensor of the sensor arrangement. The control unit can be arranged in a system control or higher-level control. In particular, the control unit may be arranged for an autofocus function. Preferably, the control unit is arranged to control both a laser beam autofocus, i.e. a focal position of the laser beam for material processing, and a sensor autofocus, i.e. a focal position of the light coupled out to the sensor arrangement.

Preferably, in preferred embodiments, the laser processing head comprises optics for adjusting a focal position of the laser beam. The optics may comprise at least one adjustable optical element for adjusting the focal position of the laser beam. The adjustable optical element may be adjustable along its optical axis or along the optical axis of the laser beam. The adjustable optical element is preferably arranged in the beam propagation direction of the laser beam in front of the coupling optics, i.e. outside the beam path of the light entering the laser processing head. In this case, the focal position of the light can remain unchanged when the focal position of the laser beam is adjusted.

The optics for adjusting a focal position of the laser beam may be, for example, an optics for collimating and/or focusing the laser beam to a laser focus. The optics may comprise a collimating optics and/or the focusing optics. The collimating optics and/or the focusing optics may comprise the at least one adjustable optical element for adjusting the focal position of the laser beam.

As used herein, the term “optical element” may comprise a lens or lens group. For example, the at least one adjustable optical element may be a lens or lens group of the optics. The at least one adjustable optical element may comprise an adjustable optical element of the focusing optics. The at least one adjustable optical element may comprise an adjustable optical element of the optics arranged in front of the focusing optics in the beam direction of the laser beam.

The laser processing head may comprise a control unit arranged to open-loop control or closed-loop control a focal position of the laser beam by adjusting the at least one optical element of the optics. In this context, a closed-loop control comprises a control and a feedback, e.g. based on an output signal of the sensor arrangement, e.g. based on light monitored by the sensor arrangement or on some other measurand. For example, the laser processing head may comprise a focal position adjusting device arranged to adjust the at least one adjustable optical element for adjusting the focal position of the laser beam. The control unit may be arranged to evaluate an output signal of a sensor of the sensor arrangement for open-loop controlling or closed-loop controlling the focal position of the laser beam.

The control unit can, for example, be arranged to automatically adjust the focal position to a desired focal position (also referred to as a control unit for autofocus). The control unit can be arranged, for example, for laser process monitoring, open-loop process control or closed-loop process control based on signals from the sensor arrangement. For example, the control unit may be arranged to adjust the focal position of the laser beam based on an output signal from at least one sensor of the sensor arrangement. The control unit may, for example, be arranged for open-loop laser process control or closed-loop laser process control by means of an output signal of the sensor arrangement or at least one sensor of the sensor arrangement.

According to a further development, the control unit of the laser processing head is arranged to synchronously adjust a focal position of the laser beam and a focal position, adapted to the focal position of the laser beam, of the light coupled out to the sensor arrangement. Thus, the control unit is arranged to synchronously adjust the focal position of the laser beam and the focal position of the light coupled out to the sensor arrangement in such a way that the adjusted focal position of the light coupled out to the sensor arrangement is adapted to the adjusted focal position of the laser beam. The control unit of the laser processing head can, for example, synchronously (simultaneously) control a focal position adjusting device of the laser processing head and an adjustment of at least one adjustable optical element of the compensating optics, i.e. synchronously within the framework of a machine cycle.

In embodiments, adjusting a focal position of the light coupled out to the sensor arrangement is matching a focal position of the light coupled out to the sensor arrangement to the focal position of the laser beam.

In preferred embodiments, the compensating optics comprises at least one optical element for adjusting a focal position of the light coupled out to the sensor arrangement. The at least one optical element can be adjustable for adjusting a focal position of the light coupled out to the sensor arrangement. The control unit can be arranged for adjusting a focal position of the laser beam by adjusting the at least one optical element of the optics and/or for adjusting a focal position of the light coupled out to the sensor arrangement by adjusting the at least one optical element of the compensating optics. The adjustment of the at least one optical element of the compensating optics can be performed synchronously with the adjustment of the at least one optical element of the optics.

Synchronous adjustment is understood to mean, in particular, adjustment in the same machine cycle. I.e., within one machine cycle, both an adjustment of the at least one optical element of the optics and an adjustment of the at least one optical element of the compensating optics take place. In particular, the control unit can be arranged to carry out an adjustment of the at least one optical element of the compensating optics extending over several machine cycles in parallel with an adjustment of the at least one optical element of the compensating optics extending over the several machine cycles in order to adjust a desired focal position of the laser beam.

In embodiments, the laser processing head comprises: at least one first actuator for adjusting the at least one adjustable optical element of the optics, at least one second actuator for adjusting the at least one adjustable optical element of the compensating optics, and the control unit or a control unit, wherein said control unit is arranged to, to control the at least one first actuator for adjusting a focal position of the laser beam by adjusting the at least one optical element of the optics and to control the at least one second actuator synchronously with the control of the at least one first actuator for adjusting a focal position of the light coupled out to the sensor arrangement by adjusting the at least one adjustable optical element of the compensating optics. The control unit can thus be arranged to control the second actuator synchronously with the control of the first actuator. The control can be performed, for example, by outputting signals to the respective actuator. An actuator may be an actuator.

The at least one adjustable optical element of the compensating optics may comprise at least two adjustable optical elements of the compensating optics. These may be adjustable independently of each other. The control unit may be arranged to adjust the at least two adjustable optical elements of the compensating optics synchronously with the adjustment of the at least one adjustable optical element of the focusing optics. The laser processing head may have at least two second actuators for adjusting the at least two adjustable optical elements of the compensating optics. The control unit can be arranged to control the at least two second actuators synchronously with the control of the at least one first actuator for adjusting a focal position of the light coupled out to the sensor arrangement by adjusting the at least two adjustable optical elements of the compensating optics. The second actuators can each be controlled differently. The at least two adjustable optical elements of the compensating optics can each be adjusted differently.

In preferred embodiments, the compensating optics is afocal. In embodiments, the compensating optics does not have an intermediate focus of the light coupled out to the sensor arrangement. This is advantageous for a compact design of the compensating optics. Furthermore, this contributes to a modular design where the compensating optics can be added to an existing laser processing head while maintaining the optical configuration of the sensor arrangement. The compensating optics can be an afocal telescope or a zoom system. In this case, not only is autofocus possible, but control over magnification is also possible.

According to embodiments of the present disclosure, the compensating optics may comprise at least one first optical element and at least one second optical element, wherein the at least one first optical element has a positive focal length and the at least one second optical element has a negative focal length. The at least one second optical element of the compensating optics may, for example, be spaced and/or spaced apart from the at least one first optical element of the compensating optics. The compensating optics may be constructed, for example, as a Galilean telescope.

The at least one adjustable optical element of the compensating optics may comprise, for example, the at least one first optical element or the at least one second optical element of the compensating optics. The at least one first optical element of the compensating optics may, for example, be an adjustable optical element or be part of an adjustable optical element. The at least one second optical element of the compensating optics may, for example, be an adjustable optical element or form part of an adjustable optical element.

In embodiments, the compensating optics comprises at least one adjustable optical element for adjusting a focal position of the light coupled out to the sensor arrangement, wherein adjusting the at least one adjustable optical element changes a distance between the at least one first optical element and the at least one second optical element.

In preferred embodiments, the compensating optics comprises at least one first lens and at least one second lens having a different ratio of refractive index and dispersion. The dispersion indicates the dependence of the speed of light on the wavelength and may also be referred to as chromatic dispersion. Different dispersion corresponds to different Abbe numbers of the lenses. For example, the compensating optics may comprise at least one first lens made of a first material and at least one second lens made of a second material, the first material and the second material having different dispersion (or a different ratio of refractive index and dispersion).

In preferred embodiments, the compensating optics comprises at least one lens having a refractive index to dispersion ratio different from the corresponding ratio of a lens of the focusing optics. In preferred embodiments, the compensating optics comprises at least one lens having a dispersion different from a dispersion of a lens of the focusing optics. This lens of the compensating optics is hereinafter also referred to as a “lens of a different dispersion”. This lens may be, for example, the first lens or the second lens. This lens may for example be comprised by the above-mentioned first optical element or the above-mentioned second optical element of the compensating optics. The lens of other dispersion may for example be comprised by the at least one adjustable optical element of the compensating optics. The lens of other dispersion may for example also be comprised by at least one other optical element of the compensating optics.

The compensating optics may comprise at least one adjustable optical element, wherein the at least one adjustable optical element and another optical element of the compensating optics may be adjustable. The at least one adjustable optical element of the compensating optics may comprise the at least one first optical element of positive focal length and/or the at least one second optical element of negative focal length. The at least one adjustable optical element of the compensating optics may comprise the at least one first lens and/or the at least one second lens, wherein the at least one first lens and the at least one second lens may have different dispersion (or may have a different ratio of refractive index and dispersion). The at least one adjustable optical element of the compensating optics may comprise the at least one lens having a different dispersion.

In embodiments, adjusting the at least one adjustable optical element of the compensating optics may change a distance between the at least one first lens and the at least one second lens of the compensating optics having different dispersion (or different ratio of refractive index and dispersion), and/or adjusting the at least one adjustable optical element of the compensating optics may change a distance between the at least one first optical element having positive focal length and the at least one second optical element having negative focal length.

In preferred embodiments, the compensating optics comprises at least one adjustable optical element for adjusting a focal position of the light coupled out to the sensor arrangement. Adjusting the focal position of the light coupled out to the sensor arrangement may comprise displacing and/or deforming and/or rotating the at least one optical element of the compensating optics. For example, the at least one adjustable optical element of the compensating optics may be adjustable and/or deformable. That is, the adjusting may comprise displacing and/or deforming and/or rotating. Displacing is understood in particular as changing a position (of the adjustable optical element) in the propagation direction of the light coupled out to the sensor arrangement.

The at least one adjustable optical element of the compensating optics may comprise, for example, one or more of:
an optical element whose position is adjustable, for example a lens or a refractive (light diffracting) optical element, such as an optical grating element;
a lens that is deformable, such as a liquid lens; and
a variable focal length Moiré lens, for example comprising grating elements that are adjustable relative to each other.

In embodiments, the sensor arrangement comprises a plurality of sensors and at least one beam splitter for splitting the light coupled out from the coupling device to the sensor arrangement among the plurality of sensors. The sensors may have sensitivity to different wavelength ranges. In particular, the sensor arrangement may comprise a sensor for infrared radiation, a sensor for back-reflected laser light, and/or a sensor for UV radiation. For example, a beam splitter may be associated with at least one sensor for coupling out a wavelength of light monitored by the sensor or a spectral range of light monitored by the sensor. For example, the beam splitter couples out a wavelength or range of wavelengths matched to the associated sensor. The beam splitter associated with the sensor is preferably arranged to transmit a wavelength of light monitored by a further sensor arranged downstream or a spectral range of light monitored by the sensor arranged downstream. This may be a different wavelength or a different spectral range. For example, the beam splitter may be transparent to the wavelength or spectral range in question. The compensating optics proves to be particularly advantageous here, as it provides the chromatic correction for the entire sensor arrangement and thus the individual sensors benefit from the chromatic correction.

According to embodiments of the invention that can be combined with the embodiments disclosed herein, the compensating optics is arranged to adjust a focal position of the light coupled out to the sensor arrangement, i.e. to adjust a focal position of the sensor arrangement. Thus, in addition to chromatic correction, a focal position of the sensor arrangement can be adapted to the focal position of the laser beam. In particular, the compensating optics can be arranged to adjust a focal position of the sensor arrangement at at least one of two wavelengths, the compensating optics being arranged to correct the chromatic aberration caused by the focusing optics for the two wavelengths. For example, the compensating optics corrects the chromatic aberration of the light coupled out to the sensor arrangement for at least two wavelengths, and the focal position of the light coupled out to the sensor arrangement is adjusted for at least one of these wavelengths by the compensating optics.

The adjustment of a focal position of the sensor arrangement can be done, for example, by adjusting at least one optical element of the compensating optics. For example, the compensating optics may comprise at least one adjustable optical element for adjusting a focal position of the sensor arrangement. The at least one adjustable optical element for adjusting a focal position of the sensor arrangement may comprise at least one optical element for correcting the chromatic aberration of the light coupled out to the sensor arrangement caused by the focusing optics. When designing the compensating optics, it may be expedient to make a compromise in which both an (at least partial) correction of the chromatic aberration of the focusing optics and an (at least approximate or at least partially adapted to the focal position of the laser beam) adjustment of the focal position of the light coupled out to the sensor arrangement are effected.

Additionally or alternatively, in embodiments, a respective sensor of the sensor arrangement may have its own focus adjustment device associated with the sensor.

In embodiments, the compensating optics may be arranged to form an achromatic optics together with the focusing optics by correcting a chromatic aberration of the light coupled out to the sensor arrangement caused by the focusing optics. An achromatic optics may also be referred to as an achromat. As a further development of an achromatic optics, an apochromatic optics or an apochromat may also be mentioned, in which the chromatic aberration is corrected for more than two different wavelengths of the light coupled out to the sensor arrangement. This may be a super apochromat in which the chromatic aberration is corrected for at least three different wavelengths of light coupled out to the sensor arrangement.

In one or more embodiments, the coupling optics is arranged to coaxially couple a field of view of the sensor arrangement to the laser beam.

In embodiments, the laser processing head comprises optics for guiding the laser beam and focusing the laser beam, wherein the optics comprise collimating optics and the focusing optics, and wherein the coupling optics are arranged between the collimating optics and the focusing optics. The arrangement between the collimating optics and the focusing optics has the advantage that the coupling optics can thus be arranged in the collimated laser beam. This makes it possible, in particular, to divide the beam, which continues to be bundled, among several sensors by beam splitters in the sensor arrangement behind the coupling optics and behind the compensating optics, without there being any undesirable effects due to different distances of the sensors from the coupling optics. In particular, coupling optics may be arranged between a collimating optics and a scanner module of the laser processing head arranged to deflect the laser beam in a plane perpendicular to the beam axis.

In another aspect, a laser processing system is disclosed comprising the laser processing head according to any of the embodiments described in this disclosure, and a fibre-coupled laser source for generating a laser beam having a power of at least 1 kW and/or having a wavelength of about 1000 nm.

### BRIEF DESCRIPTION OF THE DRAWINGS

The invention is described in detail below with reference to figures. The figures show

FIG. 1 a schematic representation of a laser processing head for processing a workpiece by means of a laser beam according to embodiments of the present disclosure;

FIG. 2 a schematic representation of compensating optics for light coupled out to a sensor arrangement;

FIG. 3 a schematic representation of glass families in an Abbe diagram;

FIG. 4 a schematic representation of properties of various optical materials in an Abbe diagram;

FIG. 5 a schematic representation of properties of different types of glass in an Abbe diagram;

FIG. 6 a schematic representation of a chromatic focus shift with and without chromatic compensation;

FIG. 7 a schematic representation of another example of a laser processing head according to embodiments of the present disclosure;

FIG. 8 a schematic representation of another example of a laser processing head according to embodiments of the present disclosure;

FIG. 9 a schematic representation of different states of a liquid lens of a compensating optics according to embodiments of the invention; and

FIG. 10 a schematic representation of a moiré lens of a compensating optics according to embodiments of the invention.

### DETAILED DESCRIPTION OF THE DRAWINGS

In the following, unless otherwise indicated, the same reference signs are used for the same elements and elements having the same effect.

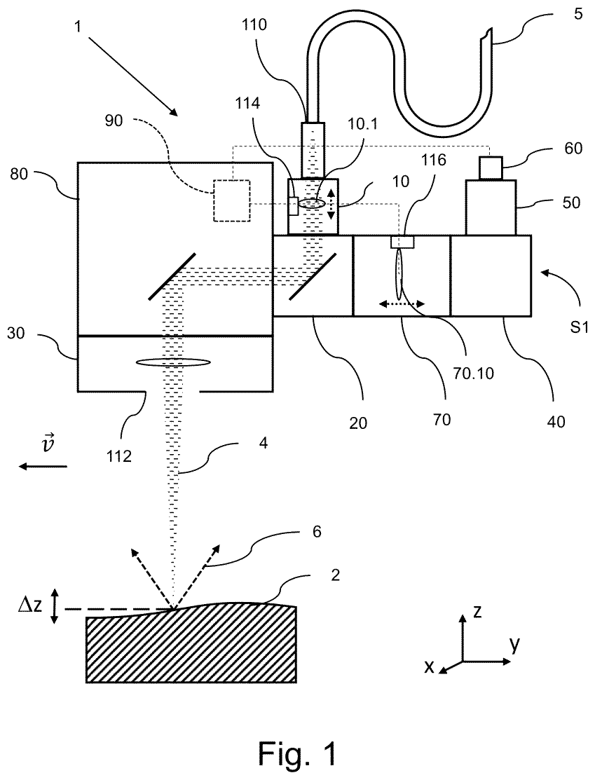

FIG. 1 shows a schematic representation of a laser processing head for processing a workpiece 2 by means of a laser beam 4 according to embodiments of the present disclosure. The laser processing head comprises a sensor module in the form of a sensor arrangement S1.

The laser processing head is arranged to focus or concentrate a laser beam 4 emitted from a laser light source or one end of a laser guide fibre 5 onto a workpiece 2 to be processed by means of a collimating and focusing optics 10, 30, thereby performing a machining or processing operation. The machining may comprise, for example, laser cutting, soldering or welding.

The laser processing head preferably comprises a scanner module 80, such as a 1-D or 2-D scanner, for deflecting the laser beam and for positioning the processing point of the laser beam 4 in the x-direction and y-direction.

The laser light entering the laser processing system 1 through an entrance opening 110 is collimated via a collimating optics 10, deflected several times, and focused on the workpiece 2 by a focusing optics 30, for example an F-theta objective.

The laser head has, for example, a feed rate \vec{v} with respect to the workpiece 2. The focused laser beam 4 emerges from a housing of the laser processing head through an exit opening 112.

The collimating optics 10 and the focusing optics 30 are part of an optics for adjusting the focal position of the laser beam 4 in the z-direction. By adjusting an optical element 10.1 of the collimating optics 10 in the beam direction of the laser beam 4, the focal position of the laser beam 4 in the z-direction resulting after the focusing optics 30 can be adjusted.

The laser processing head comprises a control unit 90 by means of which the focal position of the laser beam 4 can be adjusted by adjusting the adjustable element 10.1. The control unit 90 adjusts the adjustable element 10.1, for example, via a first actuator 114 which is associated with the adjustable element 10.1. The adjustment of the focal position of the laser beam 4 by Δz is illustrated in FIG. 1 on the adjustable element 10.1 with a dashed double arrow and on the workpiece 2 with a solid double arrow. The adjustable element 10.1 may, for example, be a collimating lens or lens group (or part thereof) of the collimating optics 10. The control unit 90 may, for example, automatically adjust the collimating module 10 to a desired focal position z of the laser beam 4.

The laser processing head comprises the sensor arrangement S1. The sensor arrangement S1 comprises, for example, a steering module 40, a sensor objective 50, and a light-sensitive sensor 60. The sensor arrangement S1 monitors light 6 in the vicinity of the laser processing point or on the workpiece 2, for example before, during and/or after a laser processing operation. Preferably, the beam path of the light 6 to the sensor arrangement S1 up to the coupling optics 20 is coaxial with the laser beam 4, as shown in FIG. 1. The control unit 90 can be connected to a signal output of the sensor arrangement S1 or of the sensor 60, for example in order to control the focal position z of the laser beam, to monitor the laser machining process, and/or to open-loop control or closed-loop control the laser process.

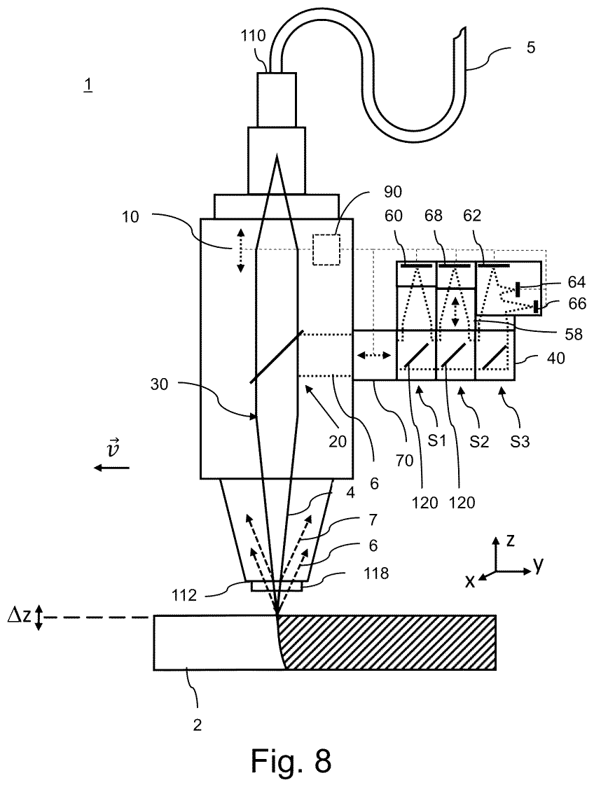

A coupling optics 20, comprising for example a beam splitter or a dichroic mirror, couples the light 6 entering the laser processing head through the exit opening 112 out to the sensor arrangement S1. The steering module 40 directs the out-coupled light 6 to the sensor 60. The coupling optics 20 also directs the laser light 4 emitted by the laser source towards the laser processing point in the example shown, in which the light 6 to the sensor arrangement S1 passes through the coupling optics 20. Of course, in the opposite case, the laser light 4 can pass through the coupling optics 20 and the light 6 can be deflected, e.g. as in FIG. 8.

A compensating optics 70 is arranged between the coupling optics 20 and the sensor arrangement S1, which corrects a chromatic aberration of the light 6 coupled out to the sensor arrangement S1 caused by the focusing optics 30. The compensating optics 70 comprises a plurality of optical elements 70.10, 70.20 which are designed to form an achromatic system together with the focusing optics 30 and the sensor objective 50. The compensating optics 70 comprises at least one adjustable optical element 70.10 for adjusting a focal position of the light 6 coupled out to the sensor arrangement S1.

The control unit 90 is further arranged to adjust the adjustable optical element 70.10 of the compensating optics 70 to adjust the focal position of the light 6 coupled out to the sensor arrangement S1. The control unit 90 adjusts the adjustable optical element 70.10, for example, by means of a second actuator 116 associated with the adjustable optical element 70.10.

The compensating optics 70 is arranged between an optical output of the laser processing system 1 for the light 6 coupled out by the coupling optics 20 and an optical input of the sensor arrangement S1 for the light 6. The compensating optics 70 acts on the light 6 coupled out in a free beam from coupling optics 20 to sensor arrangement S1.

When the adjustment of the focal position of the laser beam 4 is changed by corresponding adjustment of the beam guiding and focusing optics 10, 30, in particular by adjusting the adjustable optical element 10. 1 of the collimating optics 10, the control unit 90 controls the first actuator 114 and the second actuator 116 simultaneously or synchronously, for example stepwise synchronously, in order to carry out an adjustment (setting) of the focal position of the light 6 coupled out to the sensor arrangement S1 by the compensating optics 70 synchronously with the adjustment of the focal position of the laser beam in the z-direction. In particular, the adjustable optical element 70.10 of the compensating optics 70 is adjusted synchronously with the adjustable optical element 10.1 of the collimating optics 10. Synchronous adjustment means, in particular, adjustment within the same machine cycle.

The light 6 reflected or emitted by the workpiece surface enters the laser processing head in the opposite direction to the laser beam 4 and is guided coaxially to the beam path of the laser beam 4 to the coupling optics 20. The coupling optics 20 couples the light 6 out of the beam path of the laser beam 4 to the sensor arrangement S1. Thus, a field of view of the sensor arrangement S1 is coaxially coupled with the laser beam 4. The sensor arrangement S1 can also be referred to as an optical coaxial sensor unit. The coupling optics 20 is arranged in the beam path of the laser beam 4 between the collimating optics 10 and the focusing optics 30. The compensating optics 70, on the other hand, is arranged outside the beam path of the laser beam 4 (outside the beam path that runs in the direction of the processing point 4). By correcting the chromatic aberration of the light 6 coupled out to the sensor arrangement S1 caused by the focusing optics 30, the compensating optics 70 forms an achromatic optics together with the focusing optics 30 and can therefore also be referred to as an achromatic correcting optics.

An example of the light 6 is process radiation, i.e. reflected laser light, infrared or temperature radiation, or UV light. The at least one sensor 60 of the sensor arrangement S1 is sensitive to at least one wavelength or range of wavelengths. For example, the sensor arrangement S1 comprises a sensor for visible light and/or a sensor 60 for infrared radiation and/or a sensor 60 that is sensitive to the wavelength of laser light. Additionally or alternatively, the sensor arrangement S1 may comprise a sensor 60 for distance measurement, for example an OCT sensor. One of the sensors 60 may also be a camera, e.g. a CCD camera.

The detector or sensor 60 is arranged, for example, to detect various parameters, such as an intensity, of the light 6 and to output a measurement signal based on the detection.

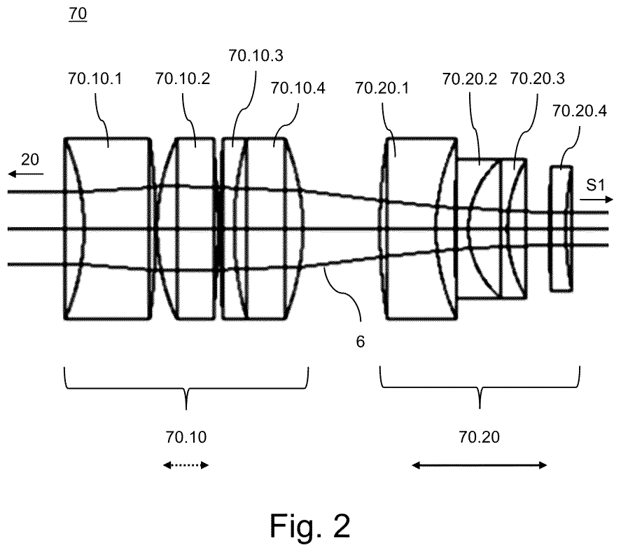

FIG. 2 shows a schematic representation of the optical structure of the compensating optics 70 for correcting the chromatic aberration, caused by the focusing optics 30, of the light 6 guided by the compensating optics 70 and coupled out to the sensor arrangement S1 and for adjusting the focal position of the coupled-out light 6.

The compensating optics 70 preferably forms an afocal system, for example with a first optical module or first optical element 70.10 and a second optical module or second optical element 70.20. The first optical element 70.10 has a positive focal length in the example shown, while the second optical element 70.20 has a negative focal length. The two optical elements 70.10 and 70.20 together form an afocal Galileo telescope.

The two optical elements 70.10 and 70.20 may, for example, be independently adjustable or movable along the optical axis. The first optical element 70.10 is movable (displaceable) in the direction of its optical axis, i.e. in the beam direction of the light coupled out to the sensor arrangement S1. The second optical element 70.20 is also movable (displaceable) in the direction of its optical axis, i.e. in the beam direction of the light 6 coupled out to the sensor arrangement S1. They are each adjustable by a second actuator 116. The optical elements 70.10 and 70.20 are spaced apart from each other, whereby the distance can be varied by moving the optical elements 70.10, 70.20 by means of the second actuators 116 by the control unit 90.

In order to correct a chromatic defocusing of the light 6 guided through the exit opening 112 and the focusing optics 30 and the coupling optics 20 to the compensating optics 70, the first adjustable optical element 70.10 comprises at least a first lens 70.10.1 having a different dispersion than a lens material of the focusing optics 30. This enables the correction of the chromatic aberration. The optical element 70.10 may include further lenses 70.10.2, 70.10.3 and 70.10.4 suitably combined with the first lens 70.10.1 to both correct chromatic aberration and provide an overall positive focal length. In one example, lenses 70.10.1 and 70.10.3 have a negative focal length, while lenses 70.10.2 and 70.10.4 combined therewith have a positive focal length. The second movable optical element 70.20 also comprises a plurality of lenses 70.20.1, 70.20.2, 70.20.3 and 70.20.4, each of which has, for example, a negative focal length.

The dispersion of the second lens 70.10.2 in particular may differ from the dispersion of the first lens 70.10.1. While in an achromatic optical system the combined lenses of different dispersion are conventionally combined with each other in such a way that an achromat is formed as a whole, in the compensating optics 70 this is done with the inclusion of the focusing optics 30.

At the same time, the adjustability of the optical elements 70.10 and 70.20 additionally enables an adjustment of the focal position of the light 6 coupled out to the sensor arrangement S1. Thus, a field of view in a desired focal position can be made available to the sensor arrangement S1 by the laser processing head in an optimised manner, in which chromatic errors of the focusing optics 30 are corrected in an optimised manner at least for one light wavelength detected by the sensor 60 of the sensor arrangement S1.

Due to the arrangement of the compensating optics 70 outside the beam path of the laser processing beam 4, a variety of materials are available for the individual lenses of the optical elements 70.10 and 70.20, i.e. without restrictions due to laser power or wavelength.

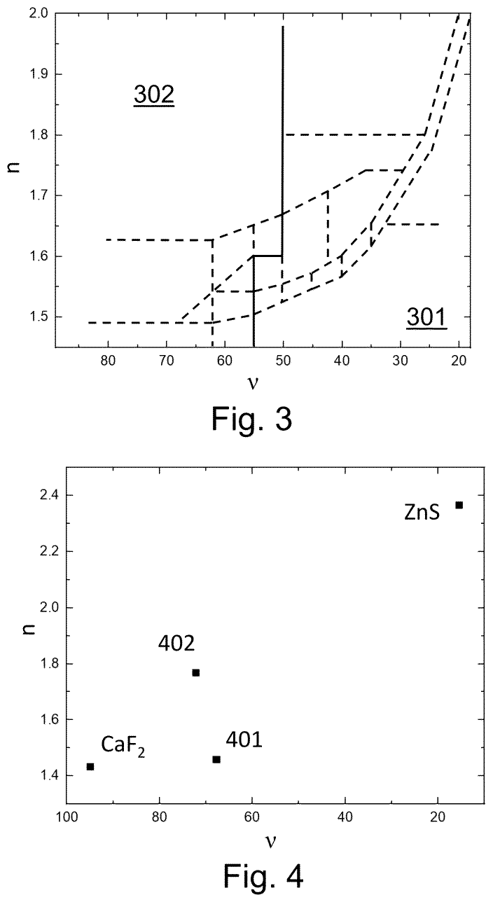

FIG. 3 schematically shows glass families in an Abbe diagram. In the Abbe diagram, the refractive index n of the material is plotted against the Abbe number v. The Abbe number, also known as Abbe's number, characterises the optical dispersion of optical materials and indicates how strongly the refractive index of the material changes as a function of the wavelength of light. In FIG. 3, dashed lines delimit known areas of different glass families, and solid lines divide the diagram into the two types of glass, flint glass (301) and crown glass (302). In embodiments, the optical elements 70.10 and/or 70.20 may comprise, for example, a lens made of one of flint glass or crown glass. In embodiments, the optical elements 70.10 and/or 70.20 may comprise, for example, a lens made of one of the optical materials identified in FIG. 4, quartz glass (401), sapphire (402), CaF2 and ZnS.

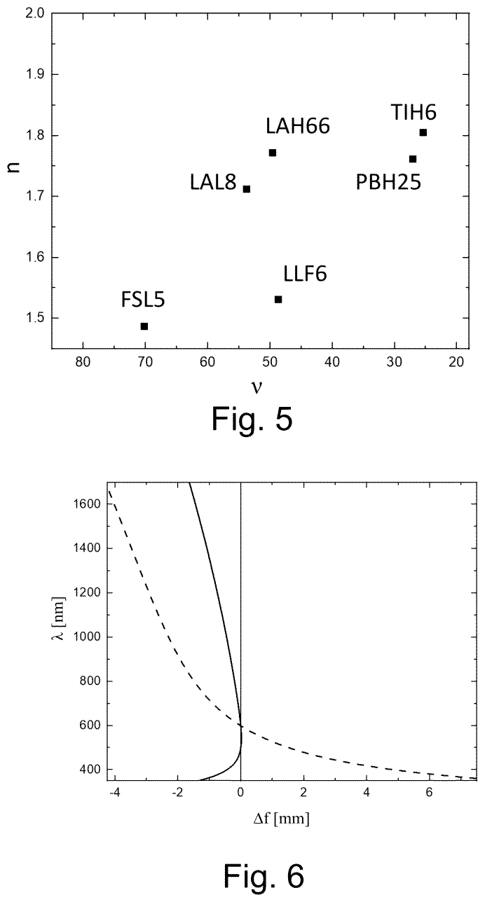

However, due to the arrangement of the compensating optics 70 outside the beam path of the laser beam 4, other materials are also available, such as plastics, or the glass types LAH66, TIH6, LAL8, PBH25, FSL5 and LLF6 shown in FIG. 5. The designations represent the usual catalogue names of the glass types. In embodiments, the optical elements 70.10 and/or 70.20 may comprise, for example, a lens made of one of the optical materials mentioned for FIG. 5 or of plastic.

FIG. 6 shows in a diagram the wavelength λ versus the chromatic focal displacement Δf, i.e. the displacing of the focal position of the sensor arrangement S1 of the field of view of the sensor arrangement S1 in the z-direction. A wavelength-dependent course of the chromatic focus shift without chromatic compensation is shown with a dashed line as an example. The wavelength-dependent course of the chromatic focus shift with chromatic compensation or correction is shown with a solid line as an example. Chromatic focus shift characterises chromatic aberration by its effect on the focal position in the direction of view. If this is not corrected, it leads to a corresponding blur at the assumed focal position. Thus, a sensor for this wavelength will see a smudged spot instead of a sharp focus. With the course of the corrected chromatic focus shift shown in FIG. 6, for example, the chromatic focus shift can be limited to an absolute value of 0.2 mm in the wavelength range from 450 to 750 nm.

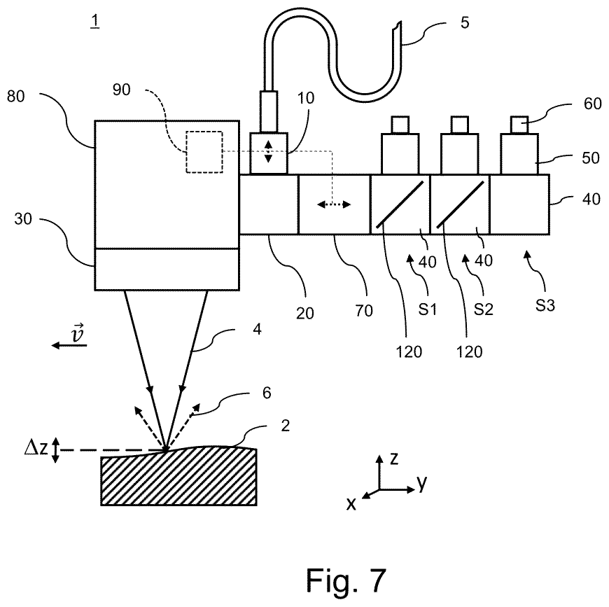

FIG. 7 shows a schematic representation of a further example of a laser processing head for processing a workpiece by means of a laser beam 4. It differs from the example of FIG. 1 in particular in that the sensor arrangement comprises three sensor modules S1, S2, S3 which are arranged one behind the other in the beam path of the light 6 coupled out from the coupling optics 20 to the sensor arrangement S1, S2, S3. The sensor modules S1, S2, S3 are arranged or coupled coaxially one behind the other. The sensor modules S1, S2, S3 can, for example, be arranged to monitor or detect light in different spectral ranges. The sensor modules S1, S2, S3 may each comprise a steering module 40 and optionally a sensor objective 50 and a sensor 60. With the exception of the rear sensor module S3 in the row, the sensor modules S1, S2 or their steering modules 40 each comprise a beam splitter 120 for splitting the light coupled out from the coupling device 20 to the plurality of sensors 60, according to respective wavelength ranges to which the respective sensors 60 are sensitive. The respective beam splitter 120 may be, for example, a dichroic mirror.

The sensors 60 of the respective sensor modules S1, S2, S3 may, for example, be arranged to monitor light of different spectral ranges. The first sensor module S1 can correspond, for example, to the multi-spectral sensor system described in DE 10 2008 060 384 B3. A sensor module S1, S2, S3 may, for example, comprise a sensor in the form of a camera. A sensor module S1, S2, S3 may comprise, for example, an optical coherence tomography (optical coherence tomography, OCT) sensor. The sensor modules S1, S2, S3 may be arranged, for example, to detect IR light, to detect visible light, to detect back-reflected laser light and/or to detect UV light. If a sensor module S1, S2, S3 comprises a light source for illuminating the field of view of an associated sensor, the illumination of the field of view of the sensor may also benefit from chromatic correction by the compensating optics 70. Particularly advantageously, in the sensor arrangement comprising a plurality of sensor modules S1, S2, S3, each of the sensor modules benefits from the chromatic correction by the compensating optics 70.

FIG. 8 shows a schematic representation of another example of a laser processing head for processing a workpiece 2 by means of a laser beam 4 according to embodiments of the present disclosure. Identical or corresponding parts are marked with the same reference numerals as in the other embodiment examples. In the example of FIG. 8, the laser processing head is used for laser cutting or welding of the workpiece 2. The laser processing head is arranged to focus a laser beam 4 emitted from a laser light source or one end of a laser guide fibre 5 onto a workpiece 2 to be processed by means of a beam guiding and focusing optics 10, 30, thereby performing a machining or processing operation. The laser beam 4 is guided in a straight line through the laser processing head. The beam and focusing optics comprise a collimating optics 10 and a focusing optics 30, between which the coupling optics 20 is arranged. The coupling optics 20 enables both the laser light 4 entering the laser processing head through the entrance opening 110 to be guided in a straight line onto the workpiece 2 and the light 6 entering the laser processing head through the exit opening 112 to be coupled out to the sensor arrangement S1, S2, S3. The laser light 4 and the outcoupled light 6 may have different wavelengths, for example, and the coupling optics 20 may comprise a beam splitter, for example.

The control unit 90 is arranged to adjust the focal position of the laser beam 4 in the vertical direction, i.e. in the z-direction, by adjusting at least one optical element of the collimating optics 10. The compensating optics 70 is arranged between the coupling optics 20 and the sensor arrangement S1, S2, S3.

Similarly to the example of FIG. 7, the sensor arrangement comprises a plurality of sensor modules S1, S2, S3 arranged in series and a plurality of steering modules 40 with beam splitters 120 for splitting the light coupled out from the coupling device 20 to the sensor arrangement S1, S2, S3 to the plurality of sensor modules S1, S2, S3 of the sensor arrangement. The sensor module S3 is, for example, the multi-spectral sensor system described in DE 10 2008 060 384 B3. As shown schematically in FIG. 8, it comprises several sensors 62, 64, 66, each of which monitors different spectral ranges of the light 6.

One of the sensor modules, in this case the sensor module S2, comprises for example an imaging sensor 68, for example a camera. For example, a camera can monitor the visible range of the spectrum of the light 6. A sensor objective 58 of the sensor module S2 may, for example, be arranged to adjust in a focal position, as illustrated by a dotted double arrow. The camera objective 58 may, for example, use one or more liquid lenses and/or polymer lenses to adjust the focal position. The sensor module S2 thus enables images, for example of the workpiece 2, to be captured at different z-positions, corresponding to different focal positions of the focal plane. In doing so, the adjustable sensor objective 58 benefits from chromatic correction by the compensating optics 70.

The sensor module S1 is used, for example, by the control unit 90 to monitor the focal position of the laser beam 4. The sensor 60 of the sensor module S1 is arranged, for example, to measure a back reflection 7 from a last optical surface in the laser processing head. The last optical surface in the beam direction of the laser processing beam 4 can be, for example, a protective glass at the exit opening 112. The sensor module S1 is thus arranged to monitor light 7 passing through the focusing optics 30 in the opposite direction to the laser beam 4. This light 7 is coupled out in the same way as the light 6 through the coupling optics 20 to the sensor arrangement S1, S2, S3.

The coupling optics 20 is optimised to achieve a high transmission of the wavelength of the laser beam 4. In the opposite direction to the laser beam 4, a small fraction of the light intensity can nevertheless be coupled out by the coupling optics 20, the coupled-out fraction of the light 7 being sufficiently large to be measured by the sensor 60 of the sensor module S1. The control unit 90 is further arranged, for example, to carry out a correction of a thermally induced focal position shift of the laser beam 4 and/or to control the focal position of the laser beam based on an output signal of the sensor 60 of the sensor module S1.

In the example described, the coupling optics 20 is thus arranged for coupling out light 7 of the laser beam 4 reflected at a protective glass 118 of the exit opening 112 to the sensor arrangement S1, S2, S3 in the same way as for coupling out light 6. The light 7 also runs coaxially with the laser beam 4 in sections.

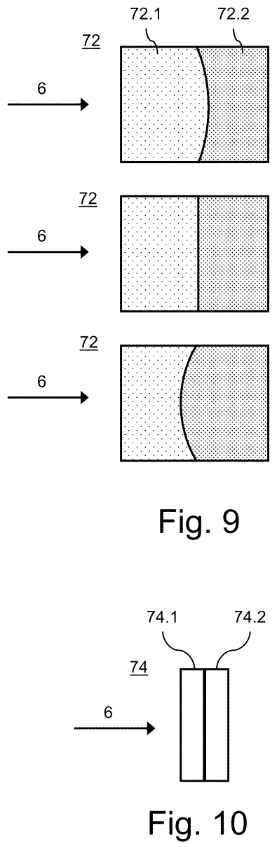

FIG. 9 schematically shows three different states of a double liquid lens 72, which comprises two liquid lenses 72.1 and 72.2. In the embodiments of the compensating optics 70 described above, one or more liquid lenses or liquid lens groups may be used as optical elements, in particular as an adjustable optical element 70.10. They can be adjusted, for example, by the control unit 90 via electrical actuators 116. For example, a double liquid lens consisting of two liquid lenses 72.1 and 72.2 of different dispersion may be used. For example, at least one of the liquid lenses 72.1 and 72.2 may have a dispersion that is different from a dispersion of a lens of the focusing optics 30. The liquid lenses 72.1 and 72.2 are adjustable optical elements. In particular, their surface shape, i.e. the shape of the lens, is adjustable to change the focal length of the respective lens. The upper part of FIG. 9 shows a condition of the double liquid lens 72 in which the first lens 72.1 has a positive focal length and the second 72.2. has a negative focal length. The middle part of FIG. 9 shows a transitional state between the state in the upper part of FIG. 9 and the state in the lower part of FIG. 9. In the lower part of FIG. 9, the focal length of the first liquid lens 72.1 has changed from positive to negative. The focal length of the second liquid lens 72.2. has changed from negative to positive. Such adjustable lenses (optical elements) 72.1., 72.2 can be used to construct the optics of the compensating optics 70 in order to correct the chromatic aberration caused by the focusing optics 30 of the light 6 coupled out to the sensor arrangement S1, S2, S3.

FIG. 10 shows another example of an adjustable optical element of the compensating optics 70 according to further embodiments of the invention. FIG. 10 shows an adjustable optical element in the form of a Moiré lens 74 with refractive optical elements 74.1, 74.2 which allow the focal length of the optical element 74 to be adjusted by relative rotation. They can be adjusted, for example, by the control unit 90 via electrical actuators 116.

In embodiments of the invention, the adjustable optical elements of the examples described above may be combined with each other as optical elements of the compensating optics 70.

According to embodiments of the present disclosure, a laser processing head, in particular a laser welding head or laser cutting head, preferably with an autofocus function for adjusting the focal position of the laser beam, with an optical coaxial sensor arrangement and compensating optics is disclosed, by means of which a chromatic aberration, in particular a chromatic defocus, caused by a focus adjustment can be corrected with minimal effort.

1. A laser processing head comprising:
optics for adjusting a focal position of the laser beam, wherein the optics have at least one adjustable optical element for adjusting the focal position of the laser beam;
focusing optics for focusing the laser beam;
an exit opening for the laser beam;
an optical sensor arrangement;
coupling optics for coupling light entering through the exit opening out of the beam path of the laser beam to the sensor arrangement; and
compensating optics for correcting a chromatic aberration, caused by the focusing optics, of the light coupled out to the sensor arrangement,
wherein the compensating optics is arranged between the coupling optics and the sensor arrangement, and
the compensating optics is arranged for adjusting a focal position of the light coupled out to the sensor arrangement.

2. The laser processing head according to claim 1, wherein the laser processing head further comprises a control unit which is arranged to synchronously adjust the focal position of the laser beam and a focal position, adapted to the focal position of the laser beam, of the light coupled out to the sensor arrangement.

3. The laser processing head according to claim 1, wherein the compensating optics has at least one adjustable optical element for adjusting a focal position of the light coupled out to the sensor arrangement.

4. The laser processing head according to claim 3, wherein adjusting the focal position of the light coupled out to the sensor arrangement comprises displacing and/or rotating and/or deforming the at least one adjustable optical element of the compensating optics.

5. The laser processing head according to claim 1, wherein the compensating optics comprises at least two optical elements which are displaceable relative to each other in coaxial direction.

6. The laser processing head according to claim 1, wherein the compensating optics comprises at least one optical element, that has a dispersion different from a dispersion of the focusing optics.

7. The laser processing head according to claim 1, wherein the compensating optics comprises a first optical element and a second optical element, the first optical element having a positive focal length and the second optical element having a negative focal length.

8. The laser processing head according to claim 7, wherein at least one of the first optical element and the second optical element is adjustable to change a distance between the first optical element and the second optical element.

9. The laser processing head according to claim 1, wherein the compensating optics is afocal.

10. The laser processing head according to claim 1, wherein the compensating optics is arranged to form an achromatic optics together with the focusing optics by correcting a chromatic aberration of the light coupled out to the sensor arrangement caused by the focusing optics.

11. The laser processing head according to claim 1, wherein the coupling optics is arranged to coaxially couple a field of view of the sensor arrangement to the laser beam.

12. The laser processing head according to claim 1, wherein the sensor arrangement comprises a plurality of sensors and at least one beam splitter for splitting the light coupled out from the coupling device to the sensor arrangement among the plurality of sensors.

13. The laser processing head according to claim 1, wherein the sensor arrangement comprises at least one of a camera, an OCT sensor, a multispectral sensor, an optical sensor for infrared radiation, an optical sensor for UV radiation, and a sensor for visible light.

14. The laser processing head according to claim 1, wherein the laser processing head further comprises a collimating optics and the coupling optics is arranged between the collimating optics and the focusing optics, and/or wherein the laser processing head further comprises a scanner module and the coupling optics is arranged in front of the scanner module in the beam propagation direction of the laser beam.

15. The laser processing head according to claim 1, wherein the focusing optics is or comprises the optics for adjusting the focal position of the laser beam, or wherein the optics for adjusting the focal position of the laser beam comprises the focusing optics.
